(19) United States
(12) Patent Application Publication
(10) Pub. No.: US 2021/0320351 A1
(43) Pub. Date: Oct. 14, 2021

(54) BATTERY FOR A BATTERY-OPERATED MOTOR VEHICLE

(71) Applicant: Mahle International GmbH, Stuttgart (DE)

(72) Inventors: Caroline Janzen, Stuttgart (DE); Heiko Neff, Auenwald (DE); Gerhard Senss, Weinstadt (DE); Johannes Weinmann, Stuttgart (DE)

(21) Appl. No.: 17/226,029

(22) Filed: Apr. 8, 2021

(30) Foreign Application Priority Data
Apr. 9, 2020 (DE) 10 2020 204 584.4

(51) Int. Cl. H01M 10/6568; H01M 10/613; H01M 10/625; H01M 10/6556; B60L 50/64

(52) U.S. Cl. CPC H01M 10/6568; H01M 10/613; H01M 2220/20; H01M 10/6556; B60L 50/64; H01M 10/625

(57) ABSTRACT

A battery for a battery-operated motor vehicle may include a housing including a receiving chamber, a module row of at least two battery modules, and a carrier. A respective battery module may include a cooling device through which a fluid is flowable. The cooling device may include two module connections. The carrier may include two fluid ducts through which the fluid is flowable. The module row and the carrier may be arranged parallel and adjacent to one another in the housing. A connecting piece may be secured to the at least one carrier via a substance-to-substance bond. The connecting piece may be arranged facing the module row and may include two fluid nozzles. A first fluid duct may be fluidically connected to a first module connection via a first fluid nozzle. A second fluid duct may be fluidically connected to the second module connection via a second fluid nozzle.

### CROSS-REFERENCE TO RELATED APPLICATIONS

This application claims priority to German Patent Application No. DE 10 2020 204 584.4, filed on Apr. 9, 2020, the contents of which is hereby incorporated by reference in its entirety.

### TECHNICAL FIELD

The invention relates to a battery for a battery-operated motor vehicle.

### BACKGROUND

In a battery-operated motor vehicle, a generic battery is used as energy source. The battery thereby usually has a housing, in which several battery modules are received and are electrically interconnected. The respective battery module is thereby formed from several individual cells, which are stacked against one another and which are electrically interconnected. Cooling devices, through which the fluid can flow and which abut on the individual cells of the battery module so as to transfer heat, are usually provided in order to cool the individual cells in the battery module. The fluid is guided to and from the respective cooling devices via additional fluid lines. It is known from US 2018/0026243 A1 to use longitudinal beams and crossbeams of the housing as fluid lines. Fluid-tight and effort-reduced connecting of the cooling devices to fluid-guiding fluid lines thereby represents a particular challenge.

### SUMMARY

It is thus the object of the invention to specify an improved or at least alternative embodiment for a battery of the generic type, in the case of which described disadvantages are overcome. A battery is to in particular be provided, in which the fluid-tight connecting of the cooling device to the fluid lines can be simplified and can take place safely.

This problem is solved according to the invention by means of the subject matter of independent claim(s). Advantageous embodiments form the subject matter of the dependent claim(s).

A battery is provided for a battery-operated motor vehicle, in particular an electric or hybrid motor vehicle. The battery comprises a housing comprising a receiving chamber and at least one module row of at least two battery modules. The respective battery module thereby comprises several individual cells, which are stacked against one another. The respective battery module further comprises a cooling device, through which the fluid can flow and which has two module connections, in each case for the fluid flow and for the fluid return. The battery comprises at least one carrier, which has two fluid ducts, through which the fluid can flow, in each case for the fluid flow and for the fluid return. The at least one module row and the at least one carrier are arranged parallel and adjacent to one another in the housing. According to the invention, at least one connecting piece is secured by means of a substance-to-substance bond to the carrier. The connecting piece is thereby arranged facing the module row and has two fluid nozzles, in each case for the fluid flow and for the fluid return. For the fluid flow and for the fluid return, the corresponding fluid duct of the carrier is in each case fluidically connected to the corresponding module connection of one of the cooling devices in the module row via the corresponding fluid nozzle of the connecting piece. The connecting piece advantageously simplifies the fluid-tight connecting of the cooling devices to the fluid ducts in the carrier.

In the case of a possible embodiment, it can be provided that the connecting piece is assigned to the battery modules, which are adjacent in the module row. The fluid nozzle for the fluid flow is thereby fluidically connected to the corresponding module connection in the one battery block, and the fluid nozzle for the fluid return is fluidically connected to the corresponding module connection in the other battery block. In the case of an alternative embodiment, the connecting piece can be assigned to one of the battery modules in the module row. The fluid nozzle for the fluid flow is then fluidically connected to the corresponding module connection of the battery block, and the fluid nozzle for the fluid return is fluidically connected to the corresponding module connection of the battery block.

The carrier can advantageously divide the receiving chamber of the housing. The carrier can advantageously be a longitudinal beam or a crossbeam. The carrier can advantageously extend over the entire length or the entire width of the housing, and can be firmly connected to side walls of the housing on the end side. It is also conceivable that the carrier represents a side wall of the housing. The carrier can be a hollow profile, in which the fluid ducts for the fluid flow and for the fluid return are then formed. It can advantageously be provided that the connecting piece and the carrier are formed from the same material. The connecting piece can advantageously be welded or soldered to or in one piece with the carrier.

In the case of an advantageous further development of the battery, it is provided that the battery comprises at least one series arrangement of two module rows and a single carrier arranged between the module rows. In the series arrangement, the cooling devices are then fluidically connected to the fluid ducts of the carrier in the two module rows via several connecting pieces. The battery can advantageously also comprise several series arrangements, which are arranged parallel and adjacent to one another in the housing and which are fluidically connected to one another. The carrier can thereby be a part of the housing and can be oriented parallel to the side walls of the housing.

In the case of an advantageous further development of the battery, it is provided that one module nozzle comprising a module flange is formed at the module connection of the respective cooling device for the fluid feed or for the fluid return, and one support flange is formed at the corresponding fluid nozzle of the connecting piece. The module flange and the support flange then abut on one another in a sealing plane and are connected to one another by means of a substance-to-substance bond. In other words, the module connection of the cooling device and the fluid nozzle of the connecting piece are directly fluidically connected to one another. The fluid-tight connecting of the cooling device to the fluid ducts can in particular take place in a simplified manner thereby, which simplifies the assembly of the battery as a whole. The module flange and the support flange can advantageously be welded together or can be produced in one piece.

The sealing plane can thereby advantageously have flange angles of between 5° and 90° to a transverse plane, which is arranged transversely to the longitudinal central axis of the carrier. The cooling device can thus already be connected to the fluid ducts in the carrier when being inserted into the housing with the preassembled carrier and the preassembled connecting piece.

It can advantageously be provided that a pipe nozzle is formed at the module connection of the respective cooling device for the fluid return or for the fluid flow. The pipe nozzle and the corresponding fluid nozzle of the connecting piece are then fluidically connected via a flexible pipe. In other words, the module connection of the cooling device and the fluid nozzle of the connecting piece are indirectly fluidically connected to one another via the pipe.

In the case of a preferred embodiment of the battery, the one module connection of the respective cooling device is directly connected and the other module connection of the respective cooling device is indirectly connected to the corresponding fluid nozzles of the connecting piece via the pipe. For this purpose, a pipe nozzle is thus formed at the one module connection, and a module nozzle comprising the module flange is formed at the other module connection. The one fluid nozzle of the connecting piece is thus formed for securing the pipe, and a nozzle flange for securing the module flange is formed at the other fluid connection.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

Preferred exemplary embodiments of the invention are illustrated in the drawings and will be described in more detail in the following description, whereby identical reference numerals refer to identical or similar or functionally identical components.

### BRIEF DESCRIPTION OF THE DRAWINGS

In each case schematically,

FIG. 1 shows a top view onto a battery according to the invention comprising several battery modules;

FIG. 2 shows a side view of two adjacent battery modules in the battery according to the invention;

FIG. 3 shows a side view of a battery module in the battery according to the invention;

FIG. 4 shows a top view onto two adjacent battery modules in the battery according to the invention.

### DETAILED DESCRIPTION

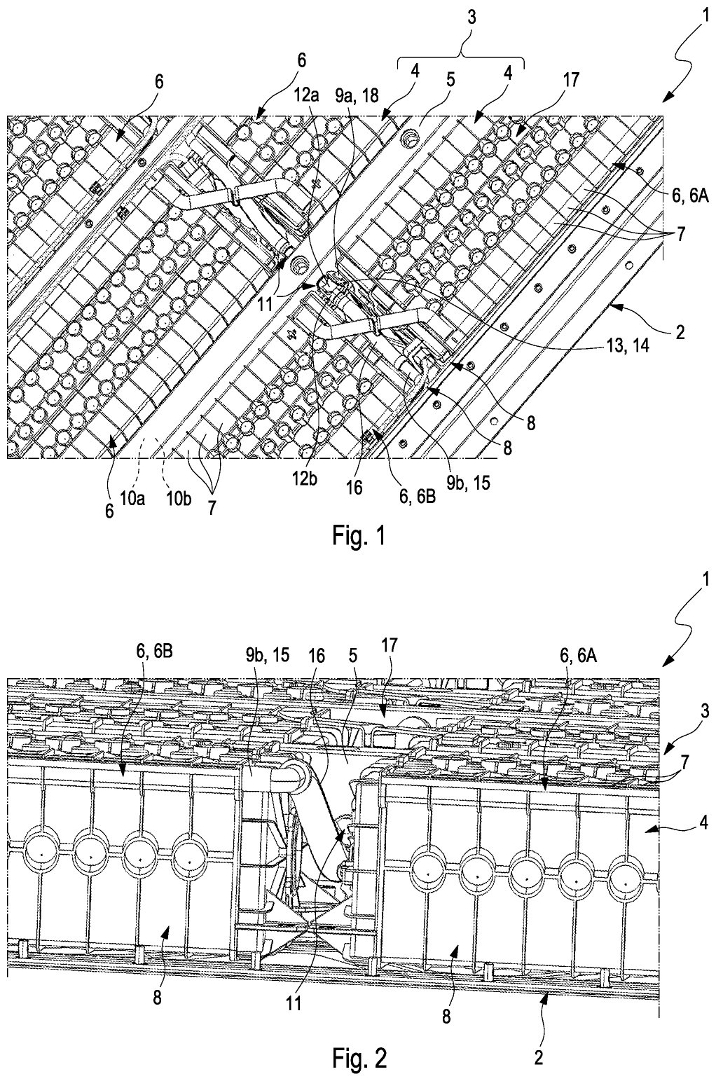

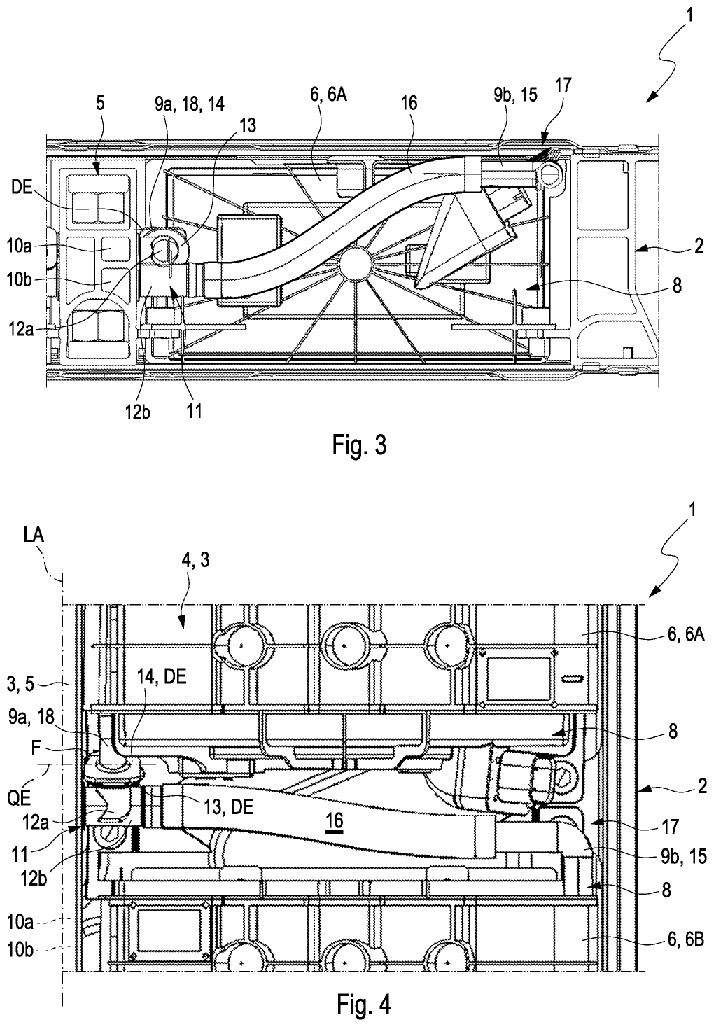

FIG. 1 shows a top view onto a battery 1 according to the invention for a battery-operated motor vehicle. The battery 1 thereby comprises a housing 2 comprising a receiving chamber 17. In this exemplary embodiment, several series arrangements 3, in each case consisting of two module rows 4 and a carrier 5 arranged between the module rows 4, are arranged in the receiving chamber 17. In the respective series arrangement 3, the module rows 4 are oriented on both sides of the carrier 5 and parallel to the latter. The respective module row 4 thereby comprises several adjacent battery modules 6. The respective battery module 6 comprises several individual cells 7, which are stacked against one another and which are electrically interconnected. FIG. 2 shows a side view of two adjacent battery modules 6 in the module row 3. FIG. 3 shows a side view of the battery module 6 in the module row 3, and FIG. 4 shows a top view onto two adjacent battery modules 6 in the module row 3.

The respective battery module 6 further comprises a cooling device 8, through which the fluid can flow and which has a module connection 9a for the fluid flow, and a module connection 9b for the fluid return. For the fluid flow, a fluid duct 10a, through which the fluid can flow, and, for the fluid return, a fluid duct 10b, through which the fluid can flow, are formed in the carrier 5, as can in particular be seen in FIG. 3. The module connections 9a and 9b of the cooling devices 8 are thereby fluidically connected to the fluid ducts 10a and 10b of the carrier 5. The fluidic connecting of the battery modules 6 of the respective series arrangement 3 to the carrier 5 of the respective series arrangement 3 takes place thereby. Several connecting pieces 11 are secured to the carrier 5 for the fluid-tight connecting of the battery modules 6. The connecting pieces 11 are thereby formed from the same material as the carriers 5 and are welded to the latter.

With reference to FIG. 3 and FIG. 4, the connecting piece 11 is arranged facing the respective module row 4 and has a fluid nozzle 12a for the fluid flow, and a fluid nozzle 12b for the fluid return. The fluid nozzle 12a of the connecting piece 11 is thus fluidically connected to the fluid duct 10a of the carrier 5, and the fluid nozzle 12b of the connecting piece 11 is fluidically connected to the fluid duct 10b of the carrier 5. In this exemplary embodiment, the connecting piece 11 is assigned to the battery modules 6, which are adjacent in the module row 4—hereinafter additionally referred to as 6A and 6B for a better understanding—. The fluid nozzle 12a is thereby fluidically connected to the module connection 9a of the cooling device 8 of the battery block 6A, and the fluid nozzle 12b is fluidically connected to the module connection 9b of the cooling device 8 of the battery block 6B. It goes without saying that the module connection 9b in the battery module 6A is fluidically connected to the fluid ducts 10a and 10b by means of a further connecting piece 11, and the module connection 9a in the battery module 6B is fluidically connected to the fluid ducts 10a and 10b by means of a further connecting piece 11.

The fluid nozzle 12a thereby has a nozzle flange 13, and the module connection 9a has a module nozzle 18 comprising a module flange 14. The module flange 14 and the support flange 13 abut on one another in a sealing plane DE. The sealing plane DE thereby has a flange angle F to a transverse plane QE, which is arranged transversely to the longitudinal central axis LA of the carrier 5. The cooling device 8 can thus already be prepositioned at the connecting piece 11, which is preassembled to the carrier 5, when the battery module 6A is inserted into the housing 2. The assembly of the battery 1 can thus be simplified. The module flange 14 and the support flange 13 can then be welded to one another, for example. A pipe nozzle 15 is formed at the module connection 9b. The pipe nozzle 15 is thereby fluidically connected to the fluid nozzle 12b via a pipe 16. The connecting pieces 11 are formed identically in the battery 1, so that the above-described design of the connecting pieces 11 applies to all connecting pieces 11 in the battery 1. In the same way, this also applies to the cooling devices 8.

The assembly and the fluidic connecting of the cooling devices 8 to the fluid ducts 10a and 10b in the carrier 5 can take place in a simplified manner in the battery 1 according to the invention by means of the connecting piece 11 comprising the nozzle flange 13 and by means of the module nozzle 18 comprising the module flange 14. The setup effort and the production costs of the battery 1 can thus be reduced.

1. A battery for a battery-operated motor vehicle, comprising:
a housing including a receiving chamber;
at least one module row of at least two battery modules;
a respective battery module of the at least two battery modules including a cooling device through which a fluid is flowable;
the cooling device including two module connections, the two module connections including a first module connection for a fluid flow and a second module connection for a fluid return;
at least one carrier including two fluid ducts, through which the fluid is flowable, the two fluid ducts including a first fluid duct for the fluid flow and a second fluid duct for the fluid return;
the at least one module row and the at least one carrier arranged parallel and adjacent to one another in the housing;
at least one connecting piece secured to the at least one carrier via a substance-to-substance bond;
the at least one connecting piece arranged facing the at least one module row and including two fluid nozzles, the two fluid nozzles including a first fluid nozzle for the fluid flow and a second fluid nozzle for the fluid return; and
wherein, for the fluid flow and for the fluid return, the first fluid duct is fluidically connected to the first module connection via the first fluid nozzle, and the second fluid duct is fluidically connected to the second module connection via the second fluid nozzle.

2. The battery according to claim 1, further comprising:
a module nozzle including a module flange, the module nozzle disposed at a module connection of the two module connections;
a support flange disposed at a fluid nozzle of the two fluid nozzles corresponding to the module connection; and
wherein the module flange and the support flange abut on one another in a sealing plane and are connected to one another via a substance-to-substance bond.

3. The battery according to claim 2, wherein the sealing plane extends at a flange angle of 5° to 90° relative to a transverse plane, which is arranged transversely to a longitudinal central axis of the at least one carrier.

4. The battery according to claim 2, wherein the module flange and the support flange are connected to one another via at least one of a welded connection and a soldered connection.

5. The battery according to claim 1, further comprising:
a pipe nozzle disposed at a module connection of the two module connections; and
a flexible pipe fluidically connecting the pipe nozzle and a fluid nozzle of the two fluid nozzles corresponding to the module connection.

6. The battery according to claim 1, wherein at least one of:
the at least one connecting piece and the at least one carrier are composed of the same material; and
the at least one connecting piece is connected to the at least one carrier via at least one of a welded connection and a soldered connection.

7. The battery according to claim 1, wherein:
the at least one connecting piece is assigned to the at least two battery modules, which are disposed adjacent to one another in the at least one module row;
the first fluid nozzle is fluidically connected to the first module connection in a first battery module of the at least two battery modules; and
the second fluid nozzle is fluidically connected to the second module connection in a second battery module of the at least two battery modules.

8. The battery according to claim 1, wherein:
the at least one connecting piece is assigned to a battery module of the at least two battery modules;
the first fluid nozzle is fluidically connected to the first module connection of the battery module; and
the second fluid nozzle is fluidically connected to the second module connection of the battery module.

9. The battery according to claim 1, further comprising at least one series arrangement, wherein:
the at least one module row includes a plurality of module rows;
the at least one connecting piece includes a plurality of connecting pieces;
the at least one series arrangement is defined by two module rows of the plurality of module rows and the at least one carrier arranged therebetween; and
in the at least one series arrangement, the cooling devices of the two module rows are fluidically connected to the two fluid ducts of the at least one carrier via the plurality of connecting pieces.

10. The battery according to claim 9, wherein the at least one series arrangement includes a plurality of series arrangements arranged parallel and adjacent to one another in the housing and which are fluidically connected to one another.

11. A battery for a battery-operated motor vehicle, comprising:
a housing including a receiving chamber;
at least one series arrangement including two module rows and a carrier arranged therebetween, the two module rows and the carrier arranged parallel and adjacent to one another in the housing;
each module row of the two module rows including at least two battery modules;
each battery module of the at least two battery modules including a cooling device through which a fluid is flowable;
the cooling device including two module connections, the two module connections including a first module connection for a fluid flow and a second module connection for a fluid return;
the carrier including two fluid ducts through which the fluid is flowable, the two fluid ducts including a first fluid duct for the fluid flow and a second fluid duct for the fluid return;
a plurality of connecting pieces secured to the carrier via a substance-to-substance bond;
the plurality of connecting pieces arranged facing at least one module row of the two module rows and including two fluid nozzles, the two fluid nozzles including a first fluid nozzle for the fluid flow and a second fluid nozzle for the fluid return; and
wherein, for the fluid flow and for the fluid return, the first fluid duct is fluidically connected to the first module connection via the first fluid nozzle, and the second fluid duct is fluidically connected to the second module connection via the second fluid nozzle.

12. The battery according to claim 11, wherein:
at least one module connection of the two module connections includes a module nozzle, the module nozzle including a module flange;
at least one fluid nozzle of the two fluid nozzles corresponding to the at least one module connection includes a support flange; and
wherein the module flange and the support flange abut on one another in a sealing plane and are connected to one another via a substance-to-substance bond.

13. The battery according to claim 12, wherein the sealing plane extends at a flange angle of 5° to 90° relative to a transverse plane, which is arranged transversely to a longitudinal central axis of the carrier.

14. The battery according to claim 12, wherein the module flange and the support flange are connected to one another via at least one of a welded connection and a soldered connection.

15. The battery according to claim 11, wherein a module connection of the two module connections includes:
a pipe nozzle; and
a flexible pipe fluidically connecting the pipe nozzle and a fluid nozzle of the two fluid nozzles corresponding to the module connection.

16. The battery according to claim 11, wherein the plurality of connecting pieces and the carrier are composed of the same material.

17. The battery according to claim 11, wherein the plurality of connecting pieces are connected to the carrier via at least one of a welded connection and a soldered connection.

18. The battery according to claim 11, wherein:
each of the plurality of connecting pieces are assigned to the at least two battery modules of an associated module row of the two module rows;
the first fluid nozzle is fluidically connected to the first module connection in a first battery module of the at least two battery modules of the associated module row; and
the second fluid nozzle is fluidically connected to the second module connection in a second battery module of the at least two battery modules of the associated module row.

19. The battery according to claim 11, wherein:
each of the plurality of connecting pieces are assigned to an associated battery module of the at least two battery modules;
the first fluid nozzle is fluidically connected to the first module connection; and
the second fluid nozzle is fluidically connected to the second module connection.

20. A battery for a battery-operated motor vehicle, comprising:
a housing including a receiving chamber;
a plurality of series arrangements fluidically connected to one another and arranged parallel and adjacent to one another in the housing;
the plurality of series arrangements each including two module rows and a carrier arranged therebetween, the two module rows and the carrier arranged parallel and adjacent to one another in the housing;
each module row of the two module rows including at least two battery modules;
each battery module of the at least two battery modules including a cooling device through which a fluid is flowable;
the cooling device including two module connections, the two module connections including a first module connection for a fluid flow and a second module connection for a fluid return;
the carrier including two fluid ducts through which the fluid is flowable, the two fluid ducts including a first fluid duct for the fluid flow and a second fluid duct for the fluid return;
the carrier further including a plurality of connecting pieces secured thereto via a substance-to-substance bond;
the plurality of connecting pieces arranged facing at least one module row of the two module rows and including two fluid nozzles, the two fluid nozzles including a first fluid nozzle for the fluid flow and a second fluid nozzle for the fluid return; and
wherein, in each of the plurality of series arrangements, the first fluid duct is fluidically connected to the first module connection via the first fluid nozzle, and the second fluid duct is fluidically connected to the second module connection via the second fluid nozzle.
